(19) United States
(12) Patent Application Publication
(10) Pub. No.: US 2013/0282610 A1
(43) Pub. Date: Oct. 24, 2013

(54) Facilitating Interactions Between Non-Profits, Businesses and Consumers

(71) Applicants: Karen L. Hungerford, Lakewood, WA (US); Lance Hungerford, Lakewood, WA (US)

(72) Inventors: Karen L. Hungerford, Lakewood, WA (US); Lance Hungerford, Lakewood, WA (US)

(21) Appl. No.: 13/922,021

(22) Filed: Jun. 19, 2013

Related U.S. Application Data
(63) Continuation of application No. 13/253,054, filed on Oct. 4, 2011.
(60) Provisional application No. 61/537,555, filed on Sep. 21, 2011.
(60) Provisional application No. 61/389,584, filed on Oct. 4, 2010.

(51) Int. Cl. G06Q 30/02

(52) U.S. Cl. CPC G06Q 30/0279
USPC 705/329

(57) ABSTRACT

Technology is disclosed for matching funding needs of an entity in need of a donation. The technology can receive information about a potential donor's desired donating requirements; store the captured information in a database; receive information about a nonprofit entity; receive from the nonprofit entity a request for a donation; automatically generate a list of matching potential donors, the list including the potential donor from which information was received, the list generated by matching the received information about the potential donor with the received information about the nonprofit entity; and enable a user of a Web site to accept or decline a donated item.

### CROSS-REFERENCE TO RELATED APPLICATION(S)

This patent application claims the benefit of U.S. Provisional Patent Application No. 61/389,584, entitled “GetResults (will be doing business as GivingGetsResults.com) Website for connecting businesses, nonprofits/schools and donors/volunteers”, filed Oct. 4, 2010 and U.S. Provisional Patent Application No. 61/537,555, entitled “SYSTEM AND METHOD OF FACILITATING INTERACTIONS BETWEEN NON-PROFITS, BUSINESSES AND CONSUMERS”, filed Sep. 21, 2011, which are both incorporated herein by reference in their entireties.

### BACKGROUND

The process under which non-profit organizations have traditionally sought donations has been costly, long and arduous. Traditionally, non-profits in search of funds have written numerous letters, e-mails, and grant requests, made phone calls, and performed personal networking activities in order to canvass long lists of potential donors in the search of ones who might be willing to part with their dollars for the reasons of donating to charity or “good cause.”

A non-profit's list of potential donors may only be formed after much laborious manual research about potential donors, e.g., by reviewing Web sites, financial statements, annual shareholders reports, other SEC filings, newspaper articles, etc. Other information may be laboriously obtained through personal networking meetings, “word of mouth” information transfer, phone calls, etc. From this information, a judgment of a potential donor's likelihood of making a donation may be assessed, e.g., a donor's history of previous charitable contribution activity, as well as any conditions, rules, or guidelines under which donations are likely to be funded could be consulted, compared, scrutinized, and analyzed. Only after laborious research, are some companies removed from the list of prospective donors, thereby culling it down into a more manageable number of potential donors for the non-profit to further pursue.

Some potential donors who may be on the list of companies contacted by the non-profit could ultimately not be able to give to the nonprofit, despite that nonprofit's efforts, if the potential donor had already exhausted their budget for charitable contributions. Other potential donors could exclude donations to a nonprofit for reasons not known to the nonprofit until after the expenditure of significant resources, time, and effort of performing various research, writing letters, and filling out forms. Some nonprofits are unknowingly disadvantaged when seeking funds from a potential donor, when they unknowingly compete for limited funds against another nonprofit seeking funds, but who happens to have a special relationship with the donor (such as being a customer or partner.)

Conversely, for the above and other reasons of information inefficiencies in the donor/donee marketplace, would-be donors struggle to find recipients worthy of their funds. In addition to a great expenditure of time, money, and effort by the non-profit in attempting to securing donations, there is a less than ideal pairing of donors with donees. Donation opportunities are squandered, and legitimate nonprofit business needs are unmet. A donee is a recipient of a donation, e.g., a nonprofit entity.

### BRIEF DESCRIPTION OF THE DRAWINGS

FIG. 1 is a block diagram of a basic and suitable computer that may employ aspects of the invention.

FIG. 2 is a block diagram illustrating a simple, yet suitable system in which aspects of the invention may operate in a networked computer environment.

FIG. 3 is a flow diagram for generating a list of potential donors matching the funding needs of nonprofits.

FIG. 4 is a flow diagram for a matching process to determine if a particular potential donor matches a particular nonprofit entity.

FIG. 5 is a schematic diagram of a home Web page which may employ aspects of the invention.

FIG. 6 is a schematic diagram of a potential donor “Microsite” Web page which may employ aspects of the invention.

FIG. 7 is a schematic diagram of a nonprofit entity “Microsite” Web page which may employ aspects of the invention.

FIG. 8A is a schematic diagram of a Web page for user account registration, which may employ aspects of the invention.

FIG. 8B is a schematic diagram of a Web page that a Web site user may use to alter the user's profile information.

FIG. 9 is a schematic diagram of Web page that a potential donor user of the Web site may use to alter the user's profile information.

FIGS. 10A-10B are schematic diagrams of “Giving Criteria” Web pages.

FIGS. 11A-11B are schematic diagrams of a nonprofit user's profile and registration Web pages.

FIGS. 12A-12B are schematic diagrams of a nonprofit “Dashboard” Web page.

FIGS. 13A-C are schematic diagrams of a “Create Donation Request” Web page.

FIG. 14 is a schematic diagram of a “Dashboard” Web page that may be used by a potential donor.

FIG. 15 is a schematic diagram of a “Donations” Web page as may be used by a potential donor.

FIG. 16 is a schematic diagram of a “Reports” Web page.

FIG. 17 is a schematic diagram of a “Search” Web page.

FIG. 18 is a schematic diagram of an “Event Calendar” Web page.

FIG. 19 is a schematic diagram of a “Local Event” Web page.

FIG. 20 is a schematic diagram of a “Giving” Web page.

FIGS. 21A-21B are schematic diagrams of “Checkout” Web pages.

FIG. 22 is a schematic diagram of an “Affiliations” Web page.

FIG. 23 is a schematic diagram of a “Thanks/Kudos approval” Web page.

Note: the headings provided herein are for convenience and do not necessarily affect the scope or interpretation of the invention.

### DETAILED DESCRIPTION

In various embodiments, the technology facilitates an increase of overall community giving and/or increases the efficiency of the giving process by measuring, identifying, communicating, and facilitating business donations/contributions toward the “better good” of the community; identifying and communicating the identities of those donors/contributors to the community; and promoting and recognizing those donors/contributors within the community. The technology may include a Web site or other software that achieves these outcomes.

In various embodiments, the technology provides a tool to match the funding needs of an entity in need or potentially in need of a donation, (for example a non-profit business, a school, a government agency, a for-profit business in need of start-up capital, a user with a desire to create a business, and so on), herein referred to as a “nonprofit”, with the donating needs of a business/potential donor, the tool hereinafter referred to as a “matching tool”. The matching tool may perform the match by capturing information about a potential donor's desired donating requirements (the requirements hereinafter referred to as the “giving criteria”); storing the captured information in a database; repeating the capturing and storing for multiple donors, receiving information about a nonprofit; additionally receiving from the nonprofit a request for a donation, the request including information about an underlying need towards which the nonprofit intends to direct the donation (the request hereinafter referred to as the “donation request”) (e.g., information about an unfunded yet desirable project, etc); comparing the potential donors' giving criteria with the stored information about the nonprofit and the donation request to generate a list of matching potential donors; optionally allowing the non-profit to review the list of matching potential donors, select potential donors or remove potential donors, and/or to tailor a message or reminder to each potential donor; notifying each of the list of matching potential donors about the matched donation opportunity; providing to each potential donor information about the donation opportunity, and allowing each potential donor to review/approve/decline/defer the donation request; for an approved donation request, i.e.: a donation, allowing the donor to optionally publish the donation for viewing by the requesting entity and also for the general public, then publishing the donation event as is appropriate; for each approved donation, notifying the nonprofit about the donation and where applicable allowing the nonprofit to reply (customized or standard) as desired.

In various embodiments, the technology provides a matching tool as described above, wherein the matching is based on at least the geographic location relating to the potential donor and the geographic location of the nonprofit, optionally the list of matching potential donors being ordered, ranked or sorted according to the distance between the locations.

In various embodiments, the technology provides a matching tool which when comparing information allows the nonprofit to manually select the potential donor to which to send the donation request. The nonprofit may make the selection e.g. from a Web page displaying a list of potential donors, or from a Web page featuring information about a particular entity registered on a Web site (the page or set of pages hereinafter referred to as a “microsite,” the featured entity being a potential donor or recipient), the information for example being helpful to a nonprofit/school to decide whether or not to make a donation request from that potential donor, for example the potential donor's giving criteria, donation history, geographic location, and so on. In some embodiments the matching tool may disallow a user from selecting a potential donor, or may reject the selection of a potential donor if that potential donor's giving criteria does not match information provided by the nonprofit (e.g. the nonprofit's profile information, the donation request, and so on.) In some embodiments, the user may select the name of a potential donor by entering the name of a potential donor into a text box, and the tool may allow auto-completion of the entered text to the name of a potential donor only if the potential donor's giving criteria match information provided by the nonprofit. In some embodiments the tool may override its decision to reject the selection of a potential donor if that potential donor has configured an option to allow non-matching donation requests.

In various embodiments, the technology provides a matching tool allowing a variety of donation types, including not only gifts, but also sponsorships (which may be event-based, or non-event based). The donation type may furthermore be refined into various categories (e.g., monetary or cash, in-kind (product), in-kind (labor), volunteer labor, gift certificate for a product, gift certificate for a service, etc.) Certain gift types (e.g., anything but cash) may be unavailable for donors who are not businesses or schools (e.g., individual users, hereinafter “consumers”). The matching tool may employ a checkout procedure to facilitate the completion of certain donation types, e.g. the checkout procedure may facilitate the completion of a cash/monetary donation by allowing the donor to enter credit card account information and automatically charge the credit card, or by allowing the donor to enter paypal account information and automatically issue a paypal money request, and so on.

In various embodiments, the technology provides a donation response tracking mechanism for automatically sending notification of a donation to a network of users and tracking the recipients' responses. A response may include clicking a thanks button, a send thanks button, a share for thanks button; sending a note to provide feedback to the donor; or clicking a hyperlink in the message to open a Web page, such as the donor's or donee's Web site or micro page; replying to a message such as an instant message, SMS message, e-mail message, and so on. An embedded tracking mechanism, (e.g., click-through tracking, Web browser session tracking, etc.) records the number of recipients notified, the notification methods used, the responses the recipients made to the notifications, including any ensuing e-commerce activity on a donor's Website (e.g, a product purchase on a donor's Web site, or an electronic donation transaction made on a donee's Website.) The information about the notifications and responses (e.g., the number of notifications and the numbers of responses, etc), may be collected and stored in a database, and may be provided to the donor/donee to facilitate determination of the efficacy of the notifications and responses for communication, marketing, or promotion purposes.

In various embodiments, the technology provides a tool that allows a nonprofit recipient of a donation to thank the donor and to allow the non-profit to provide to the donor updates showing what they've done with the donation, in order to facilitate the communication of feedback from the recipient to the donor about how the donation is or will be used, and in order to facilitate the communication of a marketing message to the community that is likely to boost the public relations of the donor.

In various embodiments, the technology facilitates e-mailing a notice of a donation by the donation recipient to a plurality of e-mail recipients, the e-mail recipients being either non-users or users of the Web site, where the e-mail contains a selectable button or hyperlink, which when clicked may be tracked by the Web site and subsequently indicated to the donor as an expression of gratitude.

In various embodiments, the technology provides a method for facilitating donations based on purchase receipts, the method allowing a store customer with a computing device to scan in the customer's purchase receipt, the device recognizing information on the purchase receipt (the scanning and recognizing such as by using a camera, a laser, or a barcode scanner, combined with appropriate image processing techniques, etc), and facilitating a donation to a nonprofit entity based on the recognized information and information stored in a database (the database containing for example potential donor information and requirements for donation, such as the purchase of a specific product at a specific store) the user optionally being queried as to the desired recipient of the donation, the user optionally being recognized and tracked in relation to the donation (such as by registering or logging in on the device), the computing device possibly being in the physical form of an in-store computing kiosk or possibly in the physical form of a mobile device (such as an application on a mobile device), the method capturing community promotions that benefit non-profits.

In various embodiments, the technology allows consumers to donate to the funding project or item of a non-profit entity, such as a non profit business or school. The consumer may make an indication of an interest to donate on a Web page, and the user may. be taken through a checkout process, during which a shopping cart may be displayed, payment information may be accepted, and order may be verified. After making the donation, the project or item to be funded may be updated to reflect a change in the project funding status, such as indicating the project or item as being closer to reaching its funding target as a result of the donation.

In various embodiments, the technology provides a giving request agent that can be added onto an e-checkout screen, the agent prompting the purchaser of the e-commerce transaction during an e-checkout purchase to optionally make a donation, the recipient of the donation configurable by the agent and/or the purchaser, the configuration optionally determinable based on the location of the purchaser and the recipient, the agent able to recognize purchasers who are stored in a database, and track the donation history of the purchaser, such as for tax deduction purposes, the agent also being configurable to allow the seller of the e-commerce transaction to match the donation according to the seller's criteria.

In various embodiments, the technology facilitates the tracking of a plurality of donations by a donor for tax purposes. The tracking including the collection of receipts or confirmation letters a donation recipient submits to the donor through the tracking system, the collected information stored in a database and viewable by the donor.

In various embodiments, the technology provides a giving counter, the giving counter embeddable into a Web site (such by using a Java Applet or other client side scripting or code, server side scripting or code, Web services, etc), the giving counter showing the number of dollars given to non-profit entities, the number of dollars given fetched or calculated from a database.

In various embodiments, the technology provides a method for analyzing donations from donating or potentially donating entities, the analysis using aggregated or averaged calculations, the method comprising: establishing a first plurality of affiliated donating or potentially donating entities which are affiliated (or have a relation), summing or averaging the donations of each of the affiliated donating entities, presenting the summed or averaged total to an analysis recipient. The method for analyzing optionally comprising as part of the presenting: allowing the viewer to view, browse, or further analyze the donations of either an individual entity of the first plurality or a second plurality of affiliated donating entities. Optionally, the establishing being based at least in part on a geographical region.

In various embodiments, the technology provides a calendar of multiple events focused on non-profit activities and business promotions that benefit non-profits, the events managed by an event manager, the event manager allowing upcoming events to be posted by non-profit entities and businesses; facilitating event planning and event advertising (such as being able to send invitations and/or reminders to potential event attendees, to track confirmation of a potential attendee's indication of planned event attendance, etc); publishing either during or after the event (and maintaining a history of) event results, the event results including the how much money was raised in connection with the event (and optionally also including additional details of the event such as: whether a “booster campaign” is needed and details thereof, additional pictures, videos, and news from the event, etc), optionally the published results being automatically delivered (such as by through an e-mail or on a Web site) to a list of recipients (such as a list of entities affiliated with the event, or other list of interested parties.)

In various embodiments, the technology facilitates matchmaking of time-sensitive donation opportunities by registering and storing the contact information of multiple Web site users, the contact information being e.g. an e-mail address, an instant messaging identity, a phone number for an SMS message, etc; by pre-establishing one or multiple affiliations between multiple Web site users; by facilitating the communication of a message from a potential donor about a donation opportunity where the communication is targeted to an affiliated group of Web site users and the message is sent to the contact address or number of the affiliated users (such as e.g.: e-mail contact information, instant messaging identity, phone number for SMS message, etc.)

In various embodiments, the technology provides a reverse matching tool, the reverse matching tool functioning similarly to the aforementioned matching tool, except the reverse matching tool captures information about a nonprofit (e.g., donation request and/or profile information associated with a nonprofit); repeats the capturing and storing for multiple nonprofits, receives a request from a potential donor to potentially make a donation, the request including the potential donor's giving criteria information; compares the information about the potential donor with the stored information about the nonprofits to generate a list of matching potential donation recipients.

Various embodiments of the invention will now be described with reference to the figures. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented herein is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overtly and specifically defined as such in this Detailed Description section.

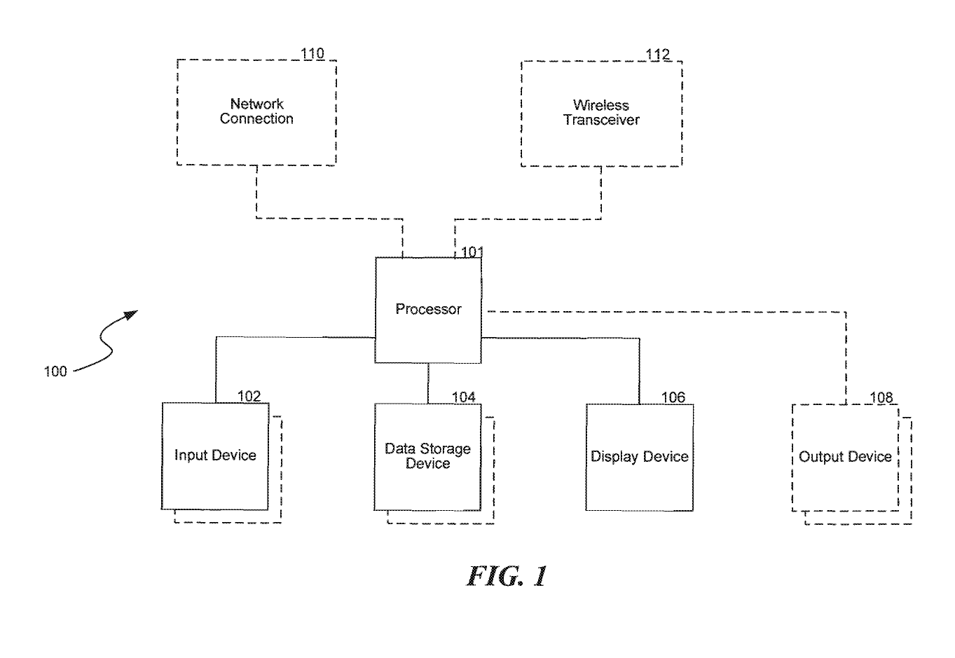

FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

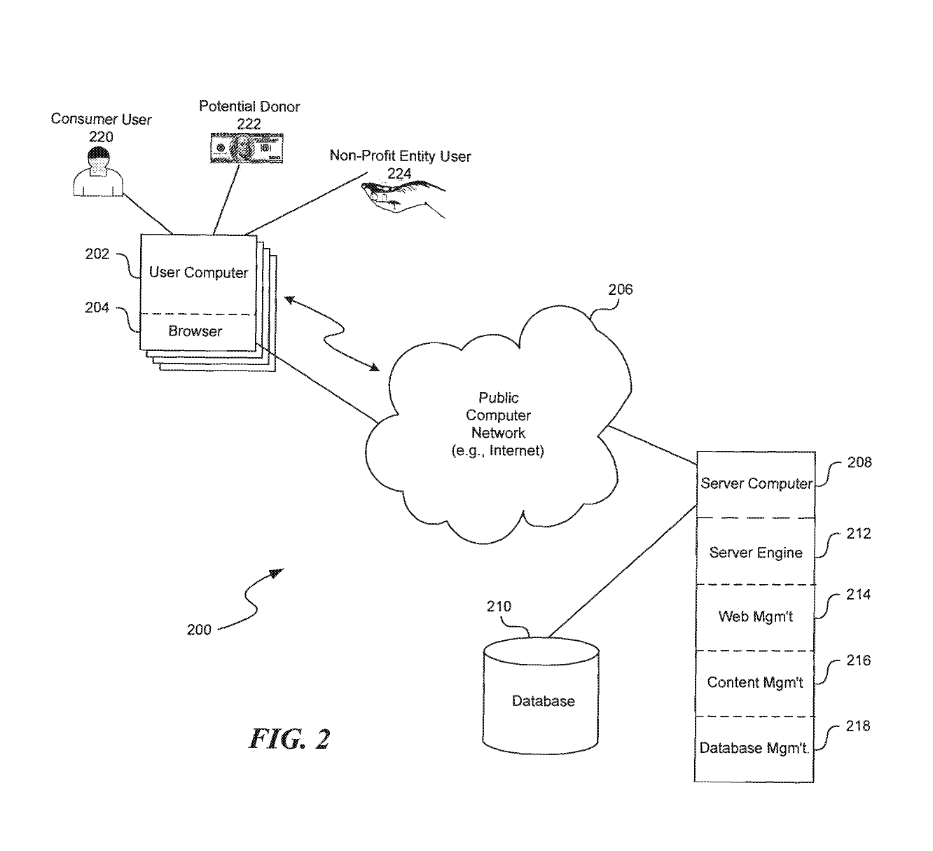

Aspects of the invention may be practiced in a variety of other computing environments. For example, referring to FIG. 2, a distributed computing environment with a Web interface includes one or more user computers 202 in a system 200 are shown, each of which includes a browser program module 204 that permits the computer to access and exchange data with the Internet 206, including Web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with Web browsers, any application program for providing a graphical user interface to users may be employed, as described in detail below; the use of a Web browser and Web interface are only used as a familiar example here.

At least one server computer 208, coupled to the Internet or World Wide Web (“Web”) 206, performs much or all of the functions for receiving, routing and storing of electronic messages, such as Web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the Web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a Web page management component 214, a content management component 216 and a database management component 218. The server engine performs basic processing and operating system level tasks. The Web page management component handles creation and display or routing of Web pages. Users may access the server computer by means of a URL associated therewith. The content management component handles most of the functions in the embodiments described herein. The database management component includes storage and retrieval tasks with respect to the database, queries to the database, and storage of data. The user computers 202 may be accessed by various users, e.g., a consumer 220, a potential donor 222, a nonprofit entity 224, etc. These users may access the same or different computers 202.

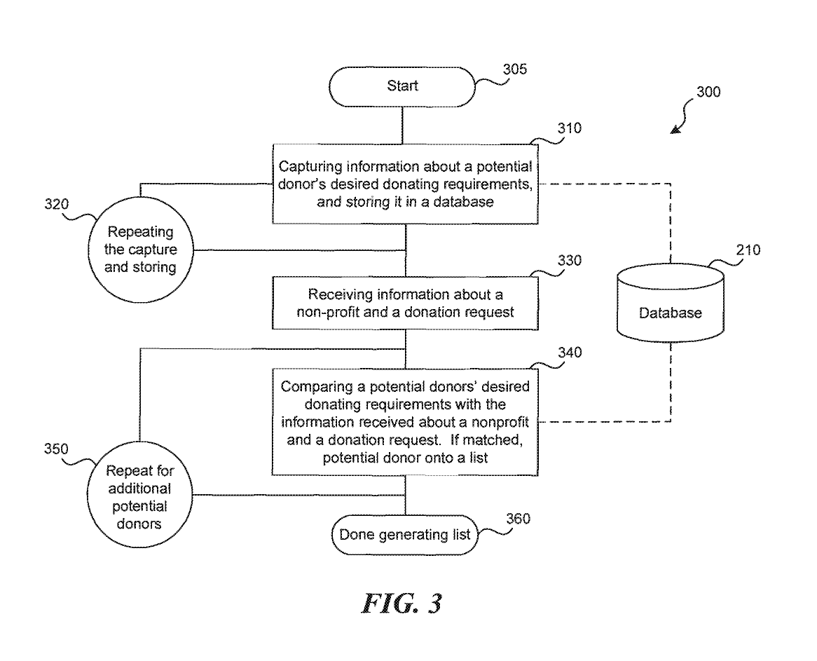

FIG. 3 is a flow diagram for generating a list of potential donors matching the funding needs of nonprofits. A routine 300 begins at block 305. At block 310, the routine 300 captures information about a potential donor's desired donating requirements, and stores it in a database. In various embodiments, the routine 300 captures this information via information provided by users who access a Web site. As an example, a potential donor may register with a Web site and provide information about desired donating requirements. The routine 300 stores the captured information in a database, e.g., database 210.

In various embodiments, the routine 300 repeats this capturing and storing (e.g., block 320) based on receiving registration or donating requirements information from additional potential donors.

At block 330, the routine receives information about a nonprofit and a donation request. As an example, the routine 300 may receive information from a user associated with a nonprofit entity. This information may be received via a Web site or other software interface, a database, etc. The routine 300 may receive information about a donation request from these or other locations.

At block 340, the routine 300 compares a potential donor's desired donating requirements with information received about a nonprofit entity and its donation requests. If the comparison results in a match, the routine 300 adds the potential donor to a list of potential donors. The routine 300 then repeats this comparison and addition for additional potential donors (e.g., at block 350). At block 360, the routine completes generating this list of potential donors. Thus, the routine 300 can create lists of potential donors for any given nonprofit entity's donation request.

In other embodiments, the routine 300 may generate a list of nonprofits for whom the potential donors may be a match. Thus, the routine 300 can create lists of nonprofit entities who may be a match for any given potential donor.

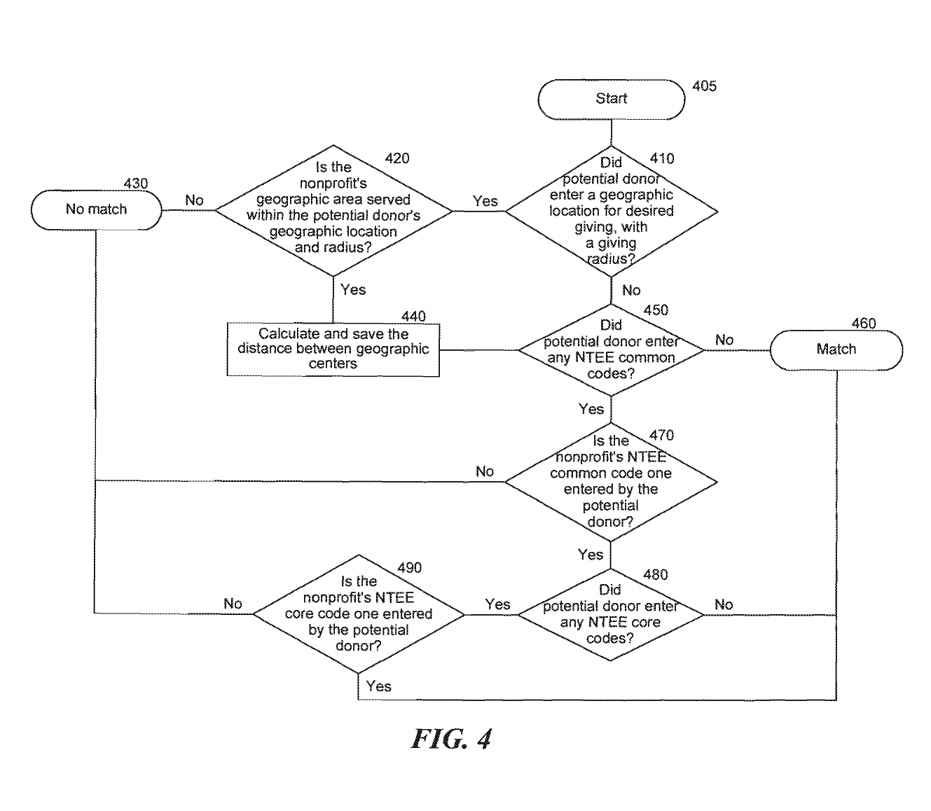

FIG. 4 is a flow diagram for a matching process to determine if a particular potential donor matches a particular nonprofit entity. In various embodiments, the routine 400 may be invoked by block 340 described above in relation to FIG. 3 to identify matches. A routine 400 begins at block 405. At decision block 410, the routine determines whether a potential donor specified a geographical location for a desired donation, e.g., with a specified radius. If the potential donor specified a geographic location, the routine continues at decision block 420. Otherwise, the routine continues at decision block 450.

At decision block 420, the routine determines whether an area indicated to be served by a nonprofit entity is within the geographic location and radius specified by the potential donor at block 410. If that is the case, the routine continues at block 440. Otherwise, the routine determines there is no match at block 430. At block 440, the routine computes and saves the distance between the geographic location specified at block 410 and the location of the nonprofit entity. In various embodiments, the distance may be measured from the specified geographic location or an edge of the circle with a center at the geographic location and the specified radius at a point closest to the location of the nonprofit entity. The routine then continues at decision block 450.

In various embodiments, the routine 400 may rank or sort potential donors based on various criteria. As an example, the routine 400 may rank or sort the potential donors based on the computed distances. In various embodiments, the ranking or sorting can be done by criteria, e.g., requested dollar amounts, potential donor's maximum dollar amounts, dates that funds are needed, donation preferences, or other criteria.

At decision block 450 the routine determines whether the potential donor identified any National Taxonomy of Exempt Entities (NTEE) common codes. The National Taxonomy of Exempt Entities codes are used by the Internal Revenue Service to classify nonprofit organizations. If the potential donor identified NTEE common codes, the routine continues at decision block 470. Otherwise, the routine continues at block 460. At decision block 470, the routine determines whether the nonprofit entity's NTEE common code is one identified by the potential donor. If the NTEE common code is one identified by the potential donor, the routine continues at decision block 480. Otherwise, the routine continues at block 430. At decision block 480, the routine determines whether the potential donor entered any NTEE core codes. If yes, the routine continues at decision block 490. Otherwise, the routine continues at block 460. At decision block 490, the routine determines whether the nonprofit entity's NTEE core code is one that was identified by the potential donor. If yes, the routine continues at block 460. Otherwise, the routine continues at block 430. At block 430, the routine determines that there is no match. At block 460, the routine determines that there is a match. Examples of NTEE common codes include e.g., A, B, C, etc. Examples of NTEE core codes include e.g., A20, B23, G25, etc.

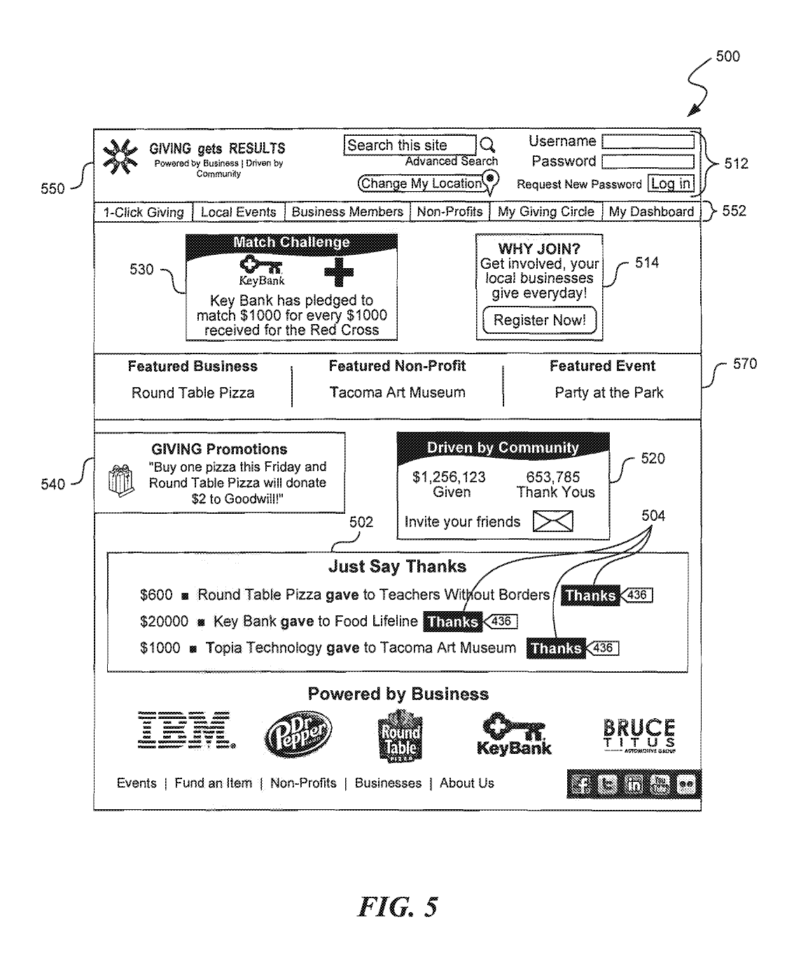

FIG. 5 is a schematic diagram of a home Web page which may employ aspects of the invention. The Web page 500 includes a region 550 that a user can use to search the Website, log in, etc. The user can log in by providing credentials, e.g., in area 512. The Web page 500 can include a navigation region 552 that the user can use to select various features provided by the Web site. The Web page 500 can include a region 530 that provides information about promotions that may be ongoing relating to entities that are willing to provide funds during sponsorship, e.g., by matching other people's sponsorship. The Web page 500 can include a region 514 that provides encouragement to people to sign up. As an example, people may be encouraged to sign up to donate or receive donations. In various embodiments, the Web page 500 may change the information displayed in various regions, including regions 530 and 514. The Web page 500 can include a region 570 that provides information about featured entities, events, etc. The Web page 500 can include a region 540 that the Web site can use to identify ongoing promotions, currently donated amounts, and provide other updates relating to donations and members of the Web site. Thus, in region 540, the Web page 500 can provide updates on the current status of giving counters. The Web page 500 can include a region 502 that encourages visitors to the Web page to thank donors and other entities, e.g., by selecting a “thanks” link 504.

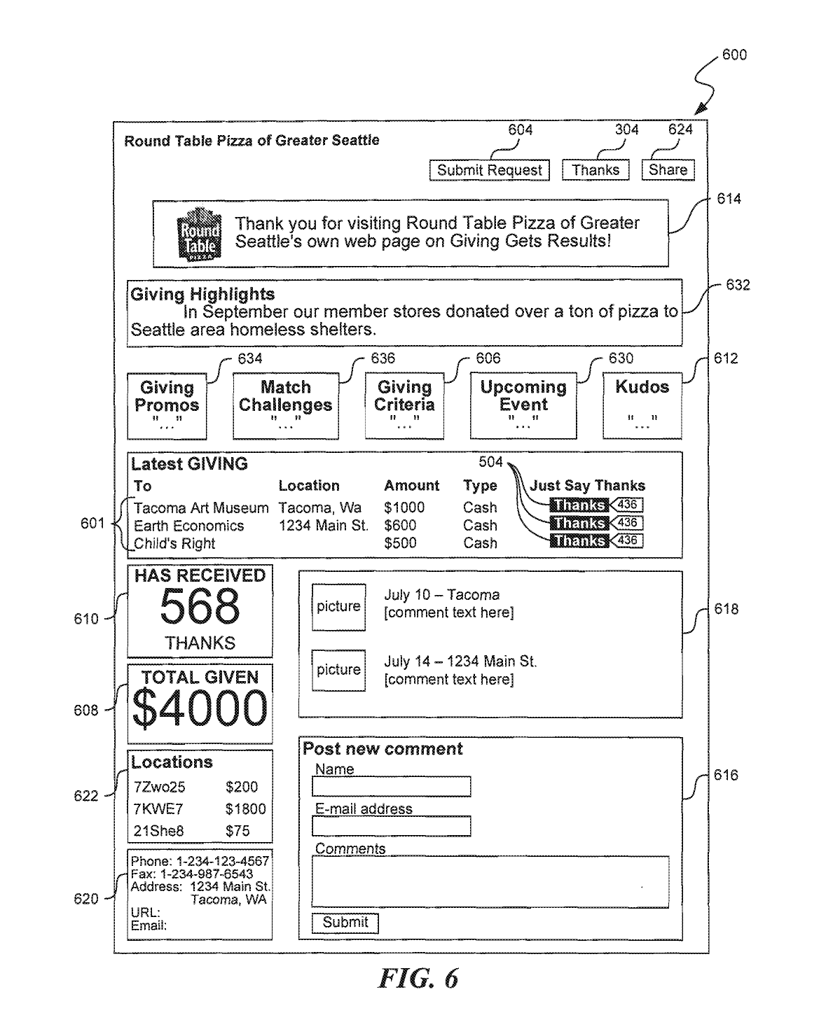

FIG. 6 is a schematic diagram of a potential donor microsite Web page which may employ aspects of the invention. The Web page 600 is associated with a microsite. The illustrated microsite is a Web page for a potential donor. Visitors to the microsite can view information about the potential donor. The Web page 600 can include a link 604 that enables a user to submit a donation request, e.g., to the potential donor. The Web page 600 can include a link 304 that a user can employ to thank a user. The Web page 600 can include a link 624 that a user can employ to share the Web page 600, e.g., with other users. In various embodiments, the Web page 600 may be shared using the social networking Web site. The Web page 600 can include various regions, e.g., regions 634, 636, 606, 630, and 612, to provide information about current, past, and future promotions, challenges, criteria, events, and thanks relating to the potential donor. The Web page 600 can include a region 601 that provides information about the donor's latest donations and enables users to thank the donor for any identified donation, e.g., by selecting a “thanks” link 504. The Web page 600 can include a region 610 that indicates the number of total thanks that the donor has received, e.g., from other users. The Web page 600 can include a region 608 that indicates the total amount that the donor has donated, e.g., within a specified period of time. When the donor associated with the microsite has multiple locations, e.g., retail locations, the Web page 600 may display a region 622 that indicates what amounts have been donated by the one or more multiple locations. These multiple locations may be referred to herein as “affiliated entities.” The Web page 600 can also include a region 620 that provides identifying information of the donor. The Web page 600 can include a region 616 that a user can use to submit comments or other information, after which the submitted information becomes visible in region 618.

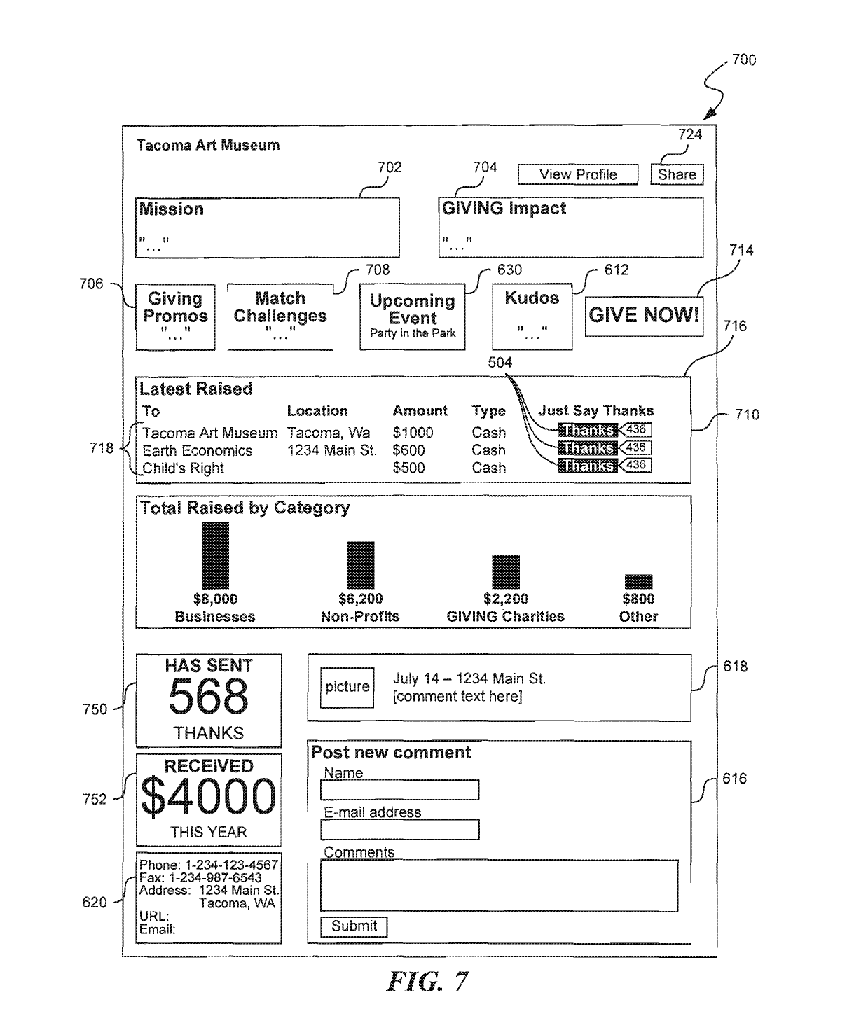

FIG. 7 is a schematic diagram of a nonprofit entity microsite Web page which may employ aspects of the invention. The Web page 700 is similar in many respects to the Web page discussed above in relation to FIG. 6, but corresponds to a nonprofit entity instead of a donor. In the Web page 700 illustrated in relation to FIG. 7, the information relates to amounts of donations, thanks, and other attributes that the nonprofit entity has received rather than the donor associated with the Web page 600 illustrated in relation to FIG. 6. The Web page 700 can include a region 714 that a user can employ to make a donation to the nonprofit entity associated with the Web page. In various embodiments, because a user has already logged in, the Web page 700 may be able to automatically associate the donation with a donor with which the user is affiliated.

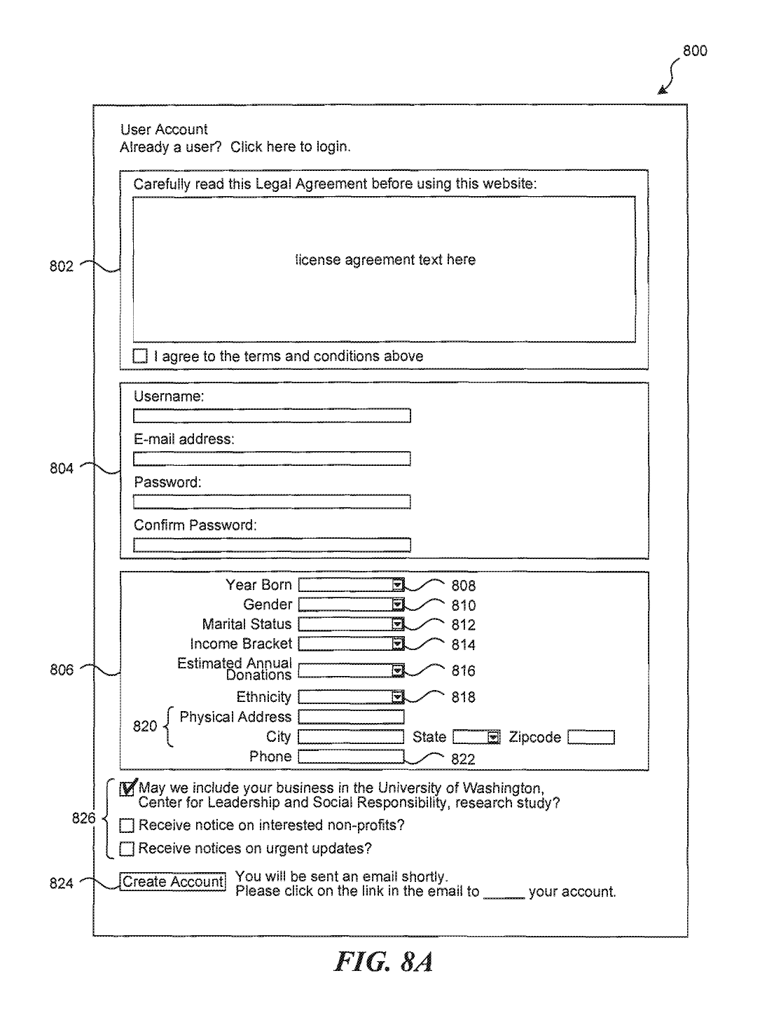

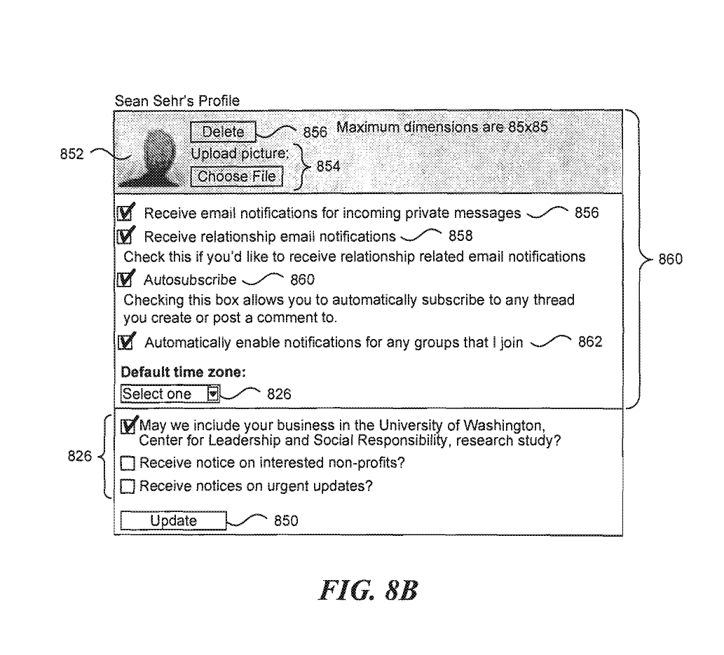

FIG. 8A is a schematic diagram of a Web page for user account registration, which may employ aspects of the invention. A Web page 800 enables a user to register with the Web site.

FIG. 8B is a schematic diagram of a Web page that a Web site user may use to alter the user's profile information.

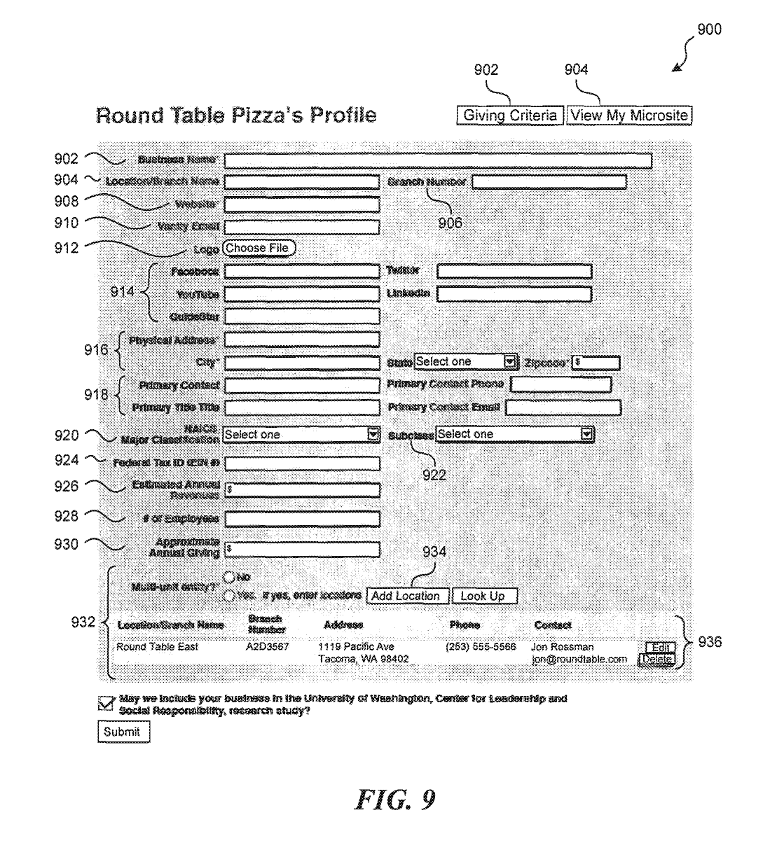

FIG. 9 is a schematic diagram of Web page that a potential donor user of the Web site may use to alter the user's profile information. A user affiliated with a donor can employ the Web page 900 to provide information about the donor, affiliated entities, contact information, etc.

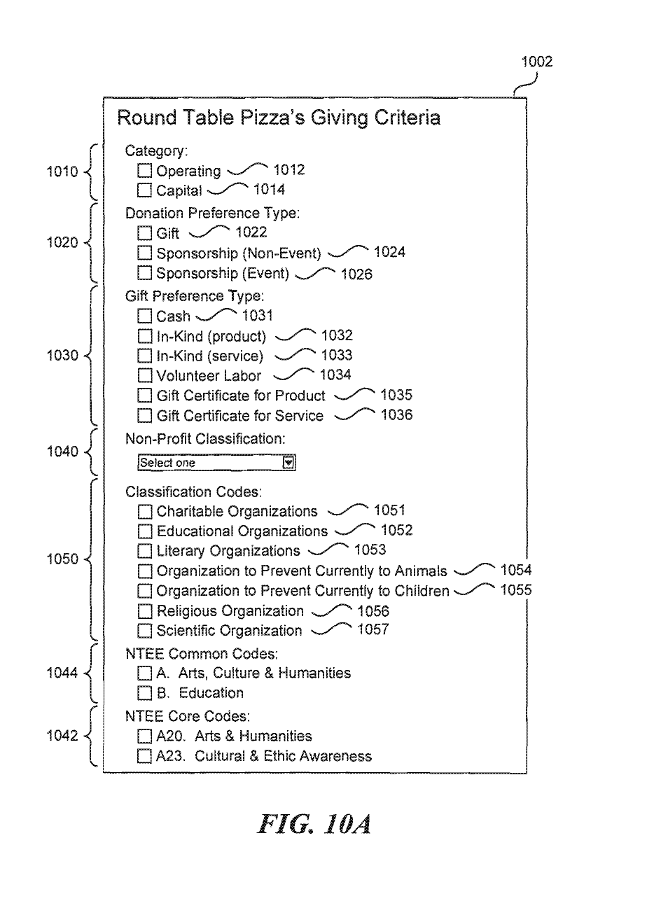

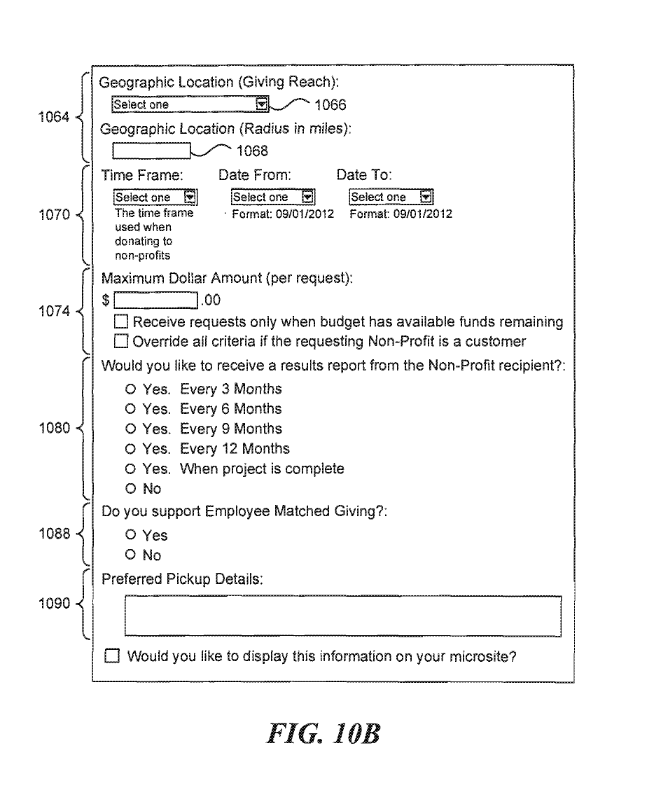

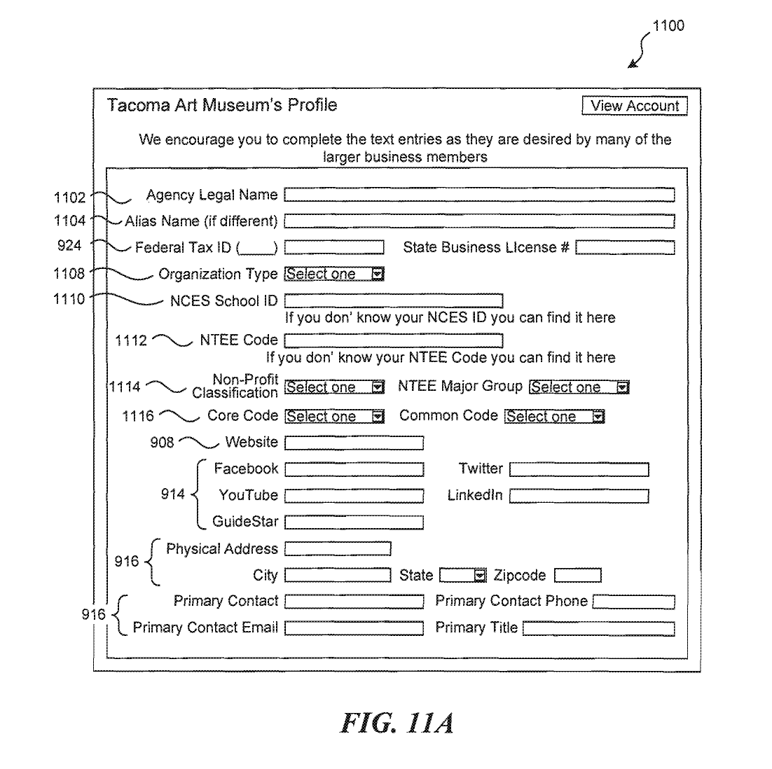

FIGS. 10A-10B are schematic diagrams of “Giving Criteria” Web pages. A user affiliated with a donor can employ form 1002 to provide information about the donor that can be employed by the Web site to match donors with nonprofit entities. The matching process is described above in relation to FIGS. 3 and 4. The attributes illustrated in FIGS. 10A and/or 10B can be employed during the matching process, e.g., when comparing a potential donor's requirements with information about nonprofit entities, e.g., during matching of giving criteria. In various embodiments, attributes associated with the potential donor and illustrated in FIG. 9 may also be employed during matching of giving criteria.

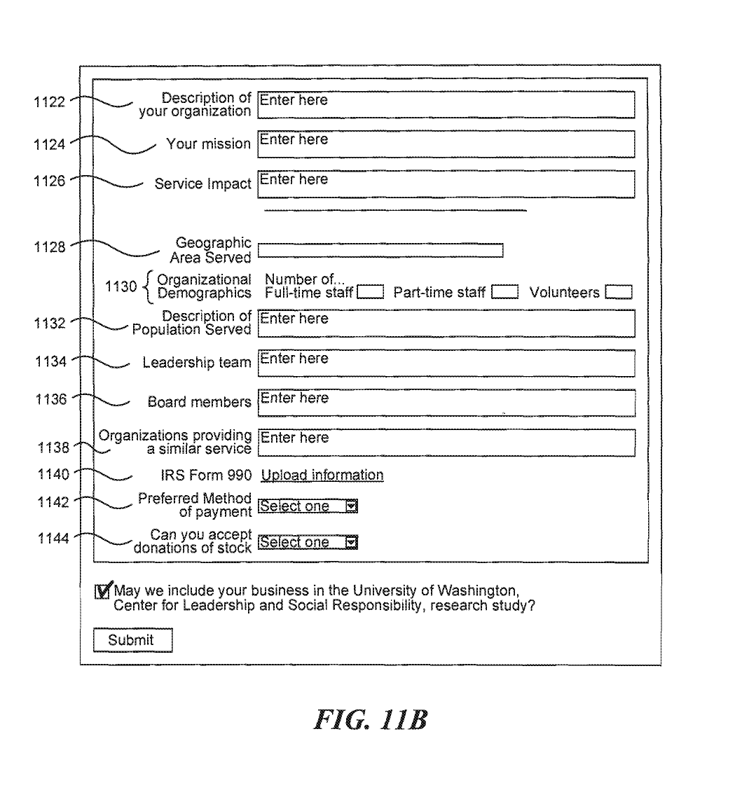

FIGS. 11A-11B are schematic diagrams of a nonprofit user's profile and registration Web pages. A user affiliated with a nonprofit entity can employ form 1100 to provide information about the nonprofit entity that can be employed by the Web site to match the nonprofit entity with potential donors. The attributes illustrated in FIGS. 11A and/or 11B can be employed during the matching process, e.g., when comparing the nonprofit entity's information with potential donors' criteria, e.g., during matching of giving criteria.

The various attributes illustrated and discussed above in relation to FIGS. 10A, 10B, 11A and 11B may be provided during registration of a user, an entity, or at other times.

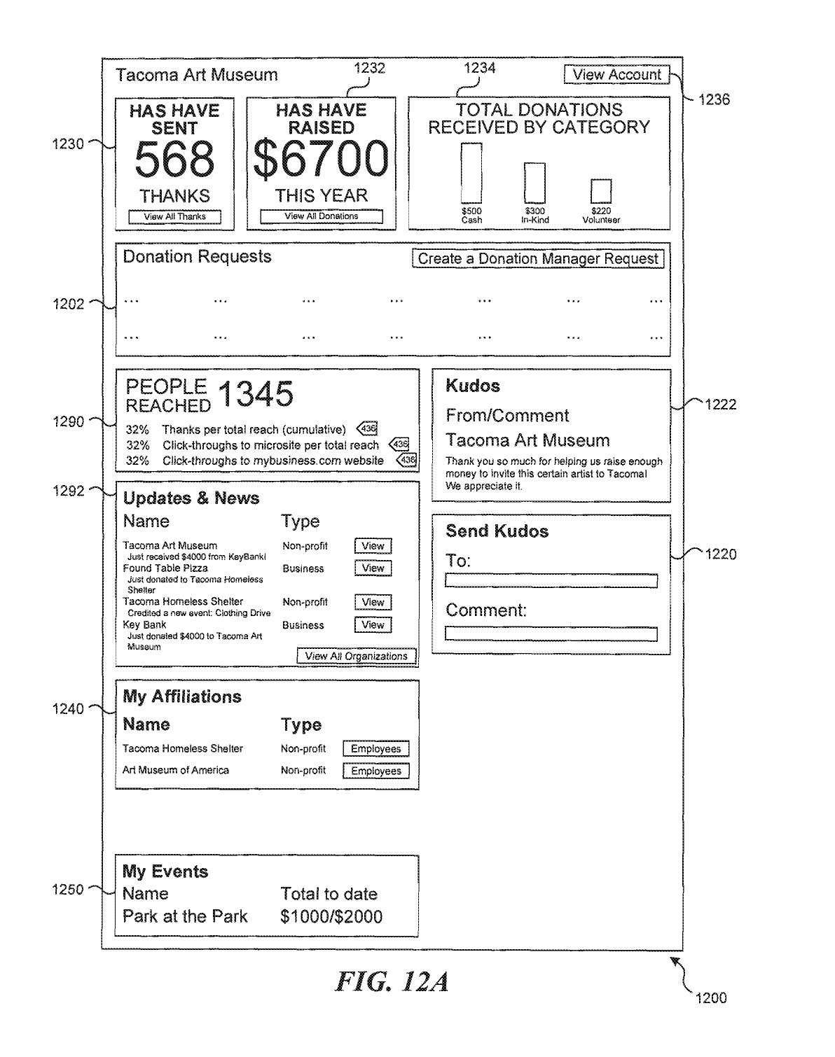

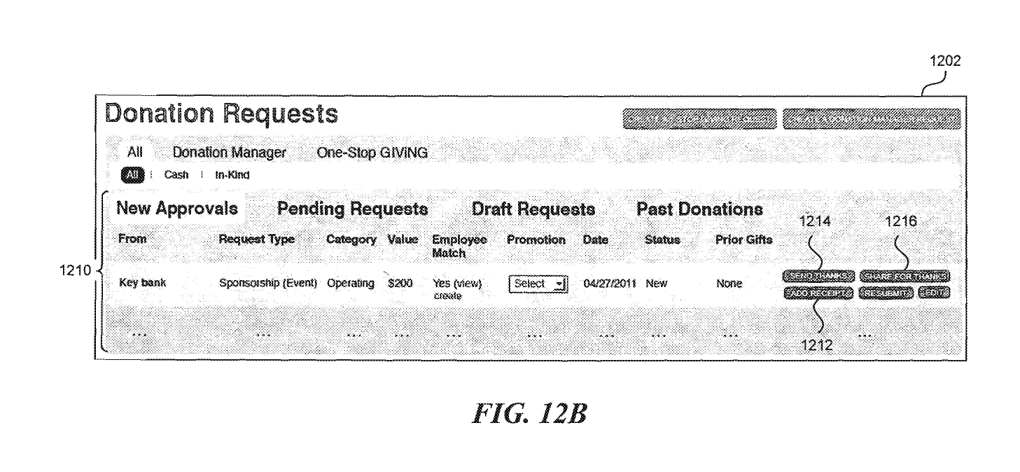

FIGS. 12A-12B are schematic diagrams of a nonprofit dashboard Web page. A Web page 1200 can provide information about a nonprofit entity in a dashboard format. As examples, the Web page 1200 can identify a number of thanks that the nonprofit entity has sent 1230, the amount that the nonprofit entity has raised 1232, categorized donations the nonprofit entity has received 1234, etc. A region 1202 is illustrated in further detail in FIG. 12B. A region 1290 can identify a number of people that the nonprofit entity has contacted using various means, e.g., using its microsite, via email, etc. Region 1202 illustrated in FIG. 12B can provide information about the status of approvals, requests, and donations, e.g., in region 1210. The region 1202 can be employed by a user associated with a nonprofit entity to manage donations, sending thanks, making requests for donations, generating and/or submitting receipts, etc.

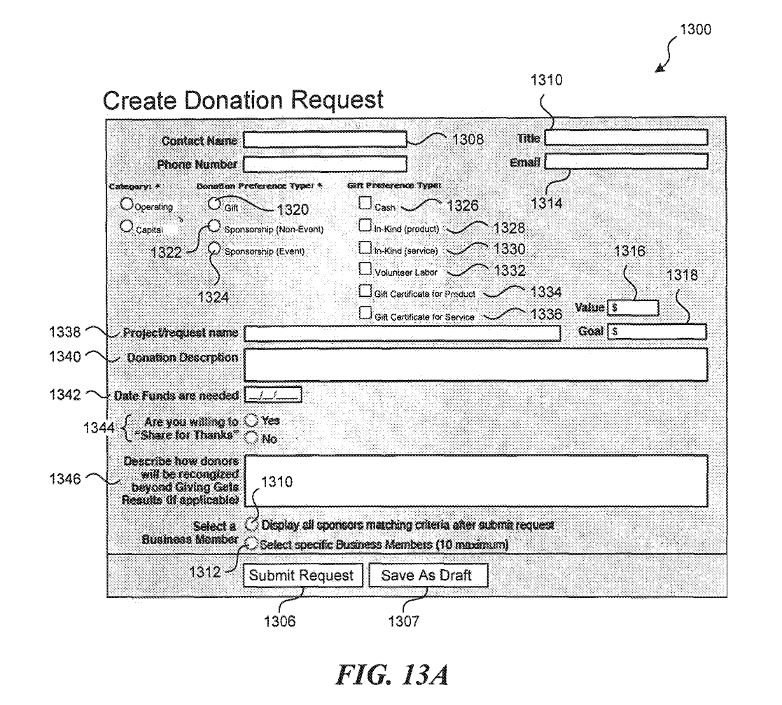

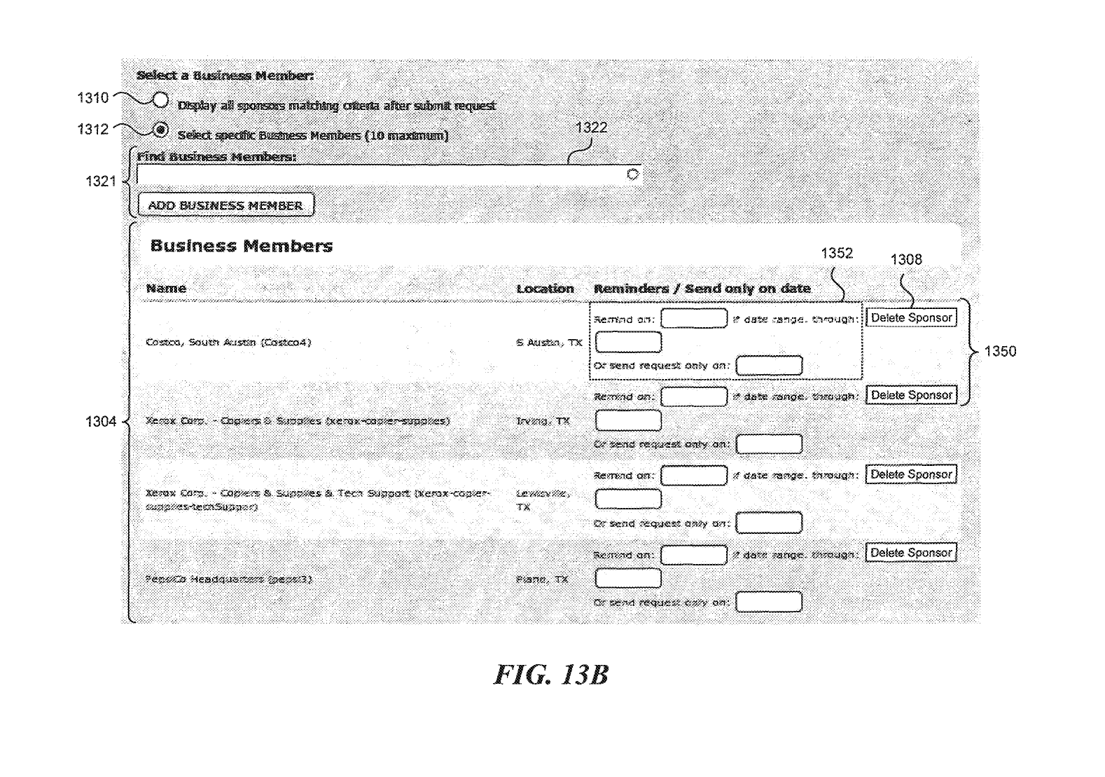

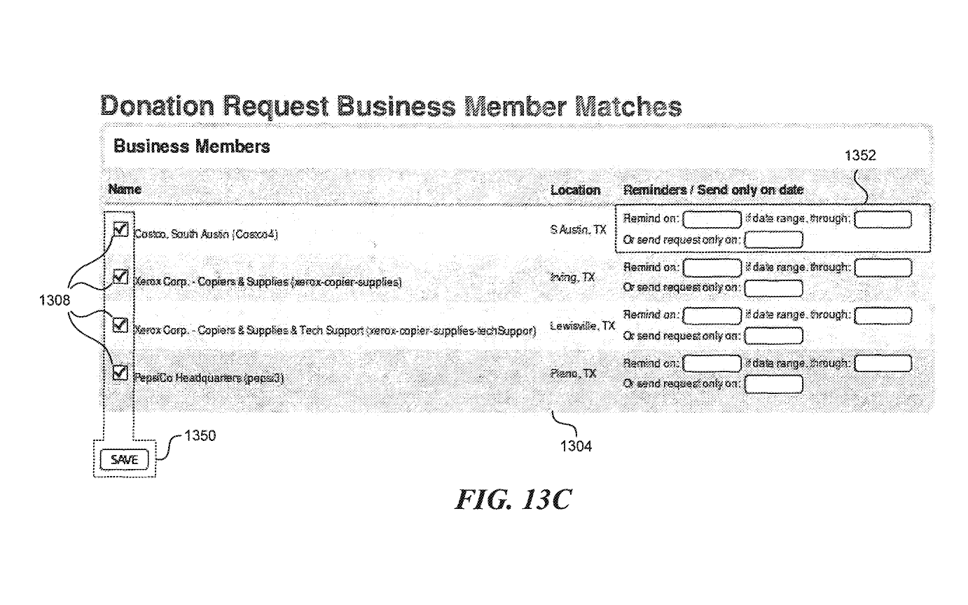

FIGS. 13A-C are schematic diagrams of “Create Donation Request” Web pages. A Web page 1300 enables a user to create a donation request. The Web page can include form fields that a user can populate with information that will be employed during the matching process. In various embodiments, the user can specify various types of donation requests, e.g., cash 1326, in-kind 1328 and 1330, labor 1332, gift certificates 1334 and 1336, etc. The Web page 1300 can include a form field 1316 that a user can populate with a value for a donation request, and a form field 1318 that a user can populate with an overall goal for several donations. If a user has selected radio button 1312, the user interface illustrated in FIG. 13B appears; and if the user has selected radio button 1310, the user interface illustrated in FIG. 13C appears. In the user interface of FIG. 13B, a user can find business members, e.g., potential donors, by typing in the business member's name in a region 1322. As each business member is found, the user can select a “add business member” link to add the found business member to a region 1304. Once added, the user can manage reminders or other communications relating to the business member. When the user has selected radio button 1310, the Web site automatically generates a list of business members, e.g., potential donors, and provides the list in region 1304. In various embodiments, the listed potential donors may be prioritized, e.g., using various criteria.

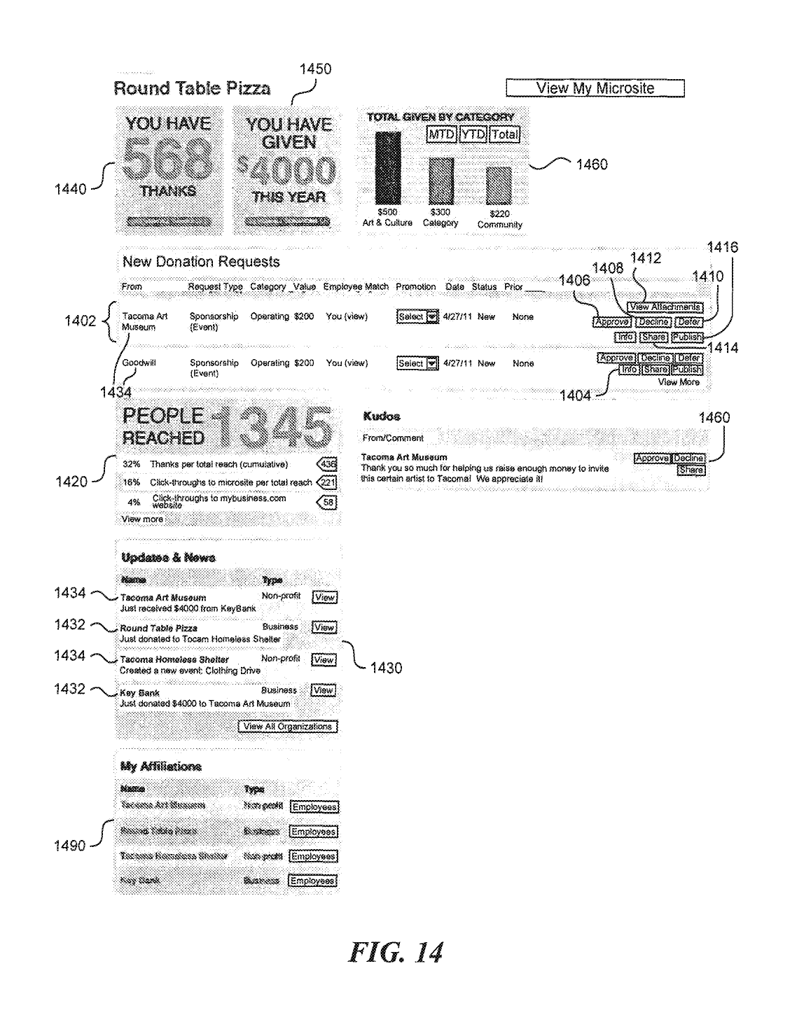

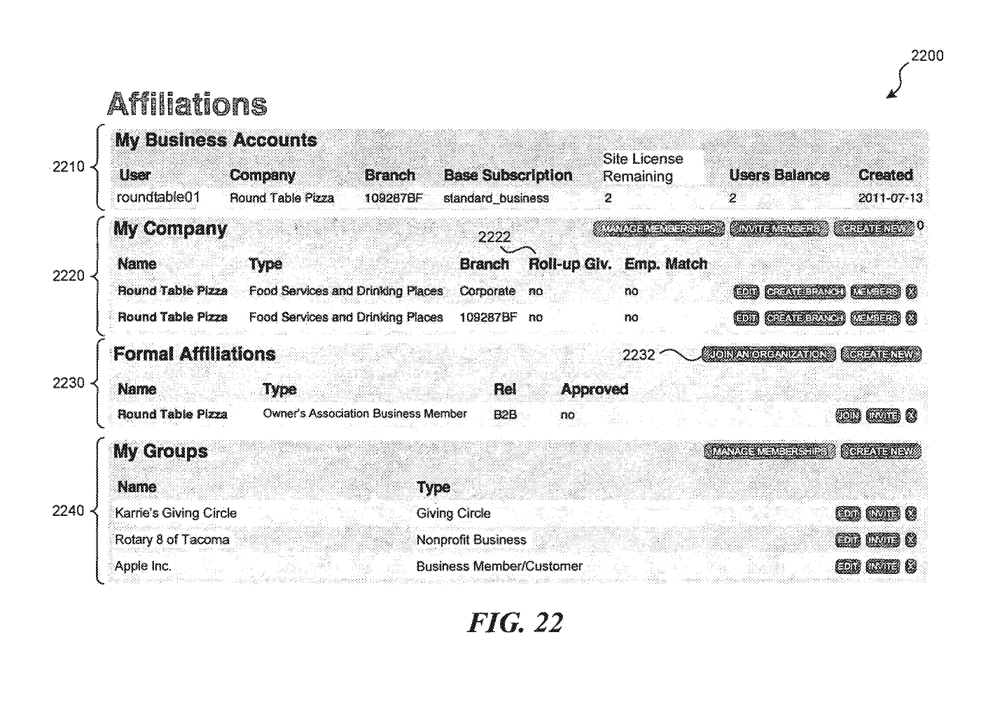

FIG. 14 is a schematic diagram of a “Dashboard” Web page that may be used by a potential donor. In various embodiments, the dashboard may enable a user to view information relating to a donor. The dashboard may also enable a user to manage donation requests, e.g., by approving, declining, or deferring submitted donation requests. In various embodiments, the dashboard may include a region 1440 that indicates a number of thanks received, a region 1450 that indicates how much the donor has donated, a categorized view of donations 1460, a number of people reached 1420, e.g., via various communications means. In various embodiments, the dashboard includes a region 1460 that a user can employ to approve, decline or share comments or thanks received from other users. The dashboard can include a region 1490 that identifies affiliations of the donor. Setting up affiliates is described in further detail below in relation to FIG. 22.

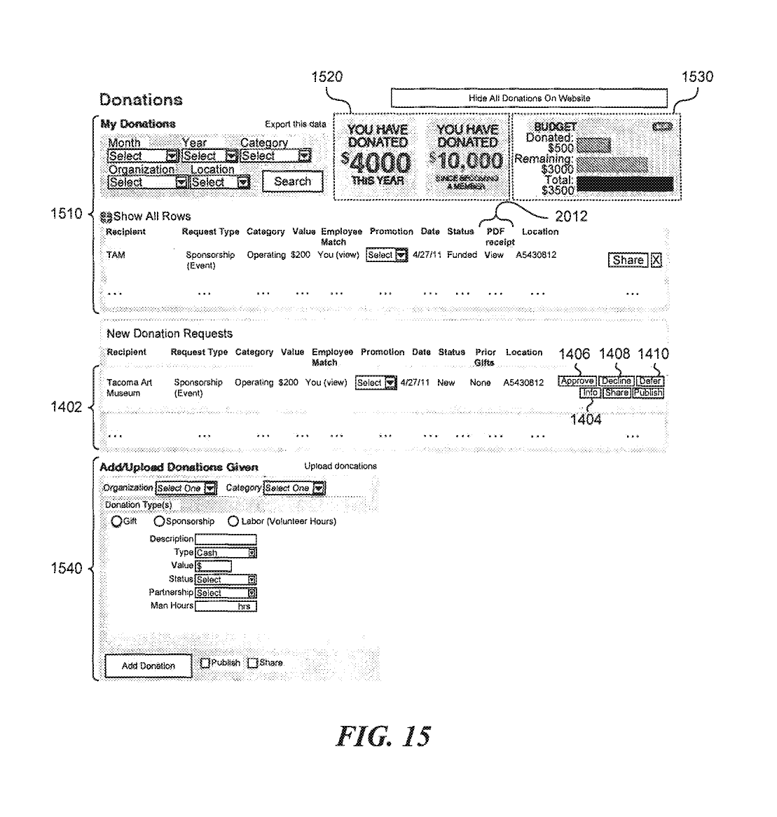

FIG. 15 is a schematic diagram of a “Donations” Web page as may be used by a potential donor. In various embodiments, the illustrated Web page enables the user to view donations in various levels of detail. As an example, a user can view a comparison between an amount donated versus an amount remaining to be donated in the aggregate, e.g., in area 1530. As another example, a user can view specific donations, e.g., in area 1510 and may be able to search for or identify donations using various criteria. The Web page can include a region 1540 that a user can employ to identify a donation, e.g., by specifying types of donations, amounts or values of donations, etc.

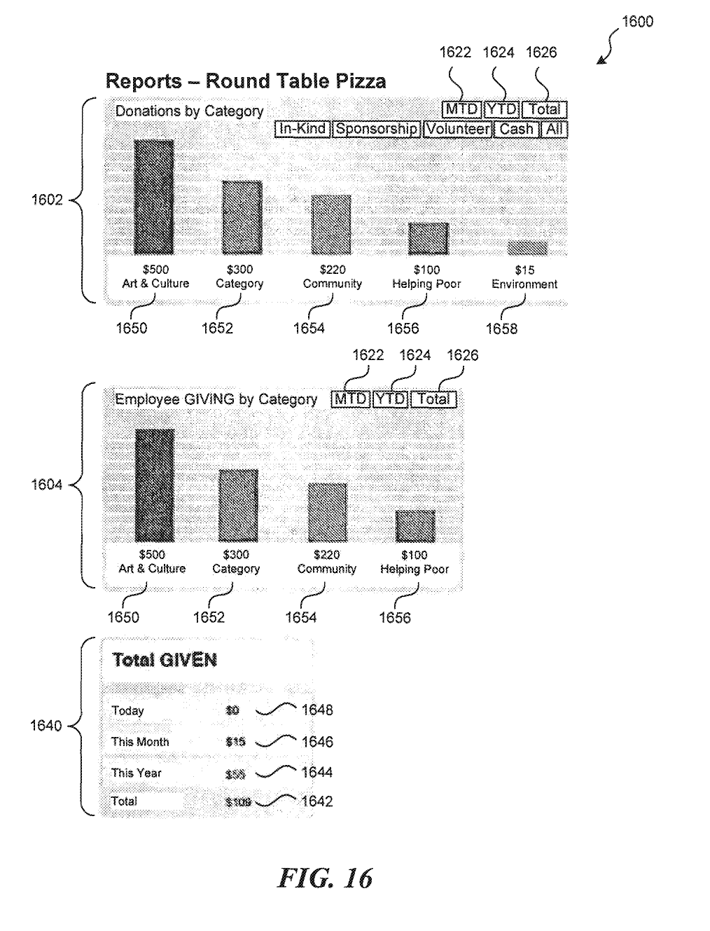

FIG. 16 is a schematic diagram of a “Reports” Web page. The Web site is capable of generating several types of reports 1600. A report 1602 can graph donations broken down by categories. A user can specify time durations for analysis, e.g., by selecting links 1622, 1624, and 1626. A report 1604 can graph donations broken down by category for groups of employees or other affiliated users. A report 1640 can identify total amounts given during various specified time periods.

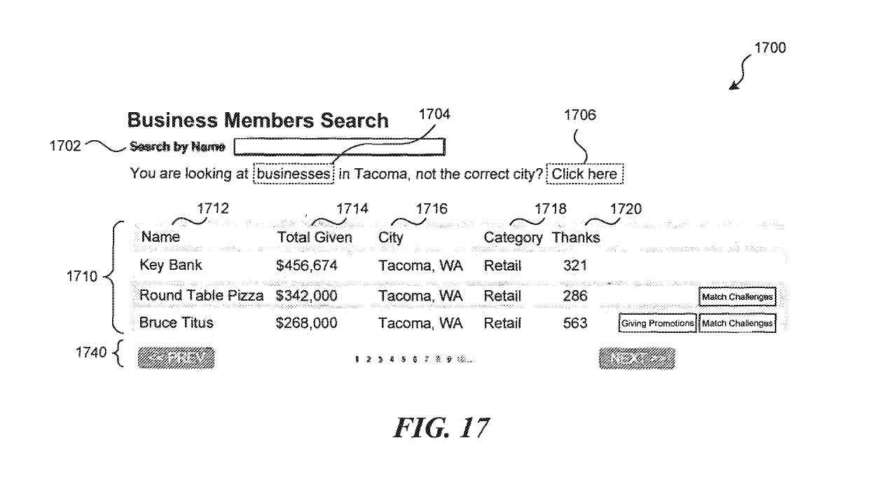

FIG. 17 is a schematic diagram of a “Search” Web page. A form 1700 enables a user to search for business members, e.g., potential donors, by providing a portion of the business member's name. The Web site can automatically search for business members by completing a partially entered name. In various embodiments, the Web site looks for business members that are located proximate to a specified geographical location, e.g., near a geographical location associated with the logged-in user. If, however, the user is interested in finding business members located in other geographical regions, the user can select a link 1706 and specify a different geographical region. The form 1700 can produce a list of matching business members in region 1710. In various embodiments, the form 1700 can enable a user to search for business members, users, and other entities using various criteria or attributes.

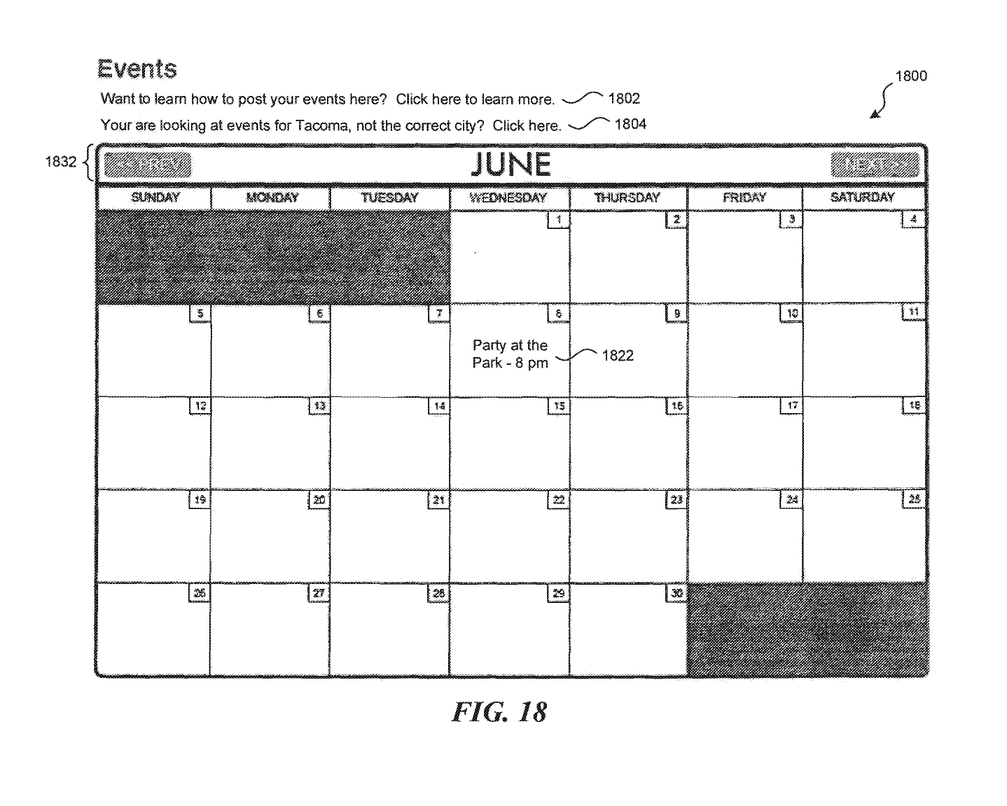

FIG. 18 is a schematic diagram of an “Event Calendar” Web page. In various embodiments, the Web site can include an events calendar 1800 that provides a calendar view of giving-related events within a specified geographical area. The user can change the geographical area, e.g., by selecting a link 1804.

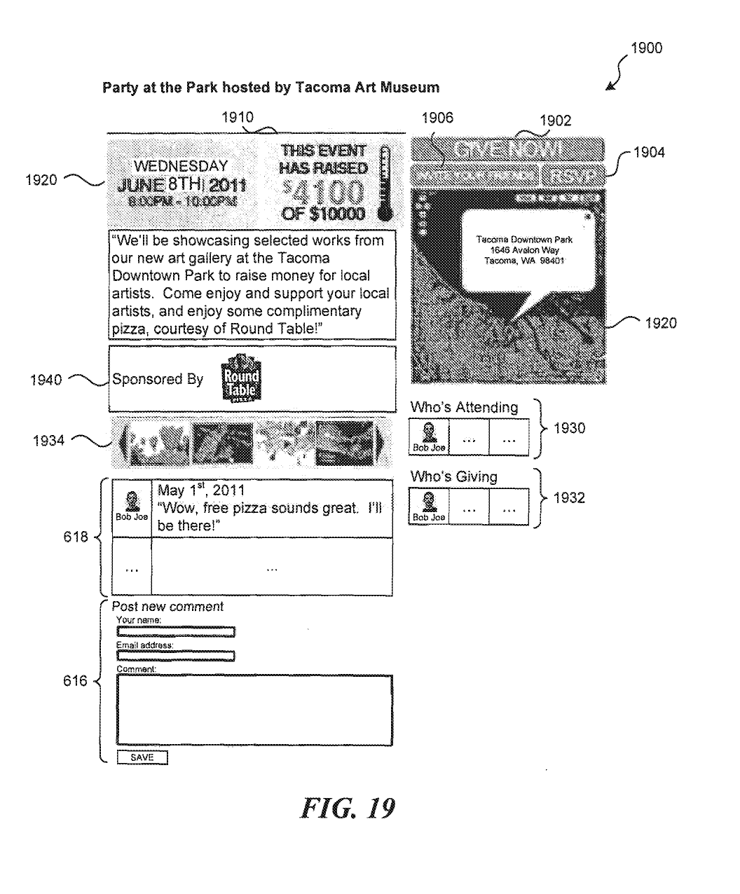

FIG. 19 is a schematic diagram of a “Local Event” Web page. A Web page 1900 enables a user to view details associated with a particular event, e.g., an event identified in the events calendar illustrated in FIG. 18. The Web page 1900 can be employed by an events manager to facilitate event planning and advertising. The Web page 1900 can display links to invite others to donate, respond to an invitation, view sponsors, see who else is attending, see who else is donating, post comments, and generally view the status of the giving event, e.g., total donated versus the nonprofit entity's goal.

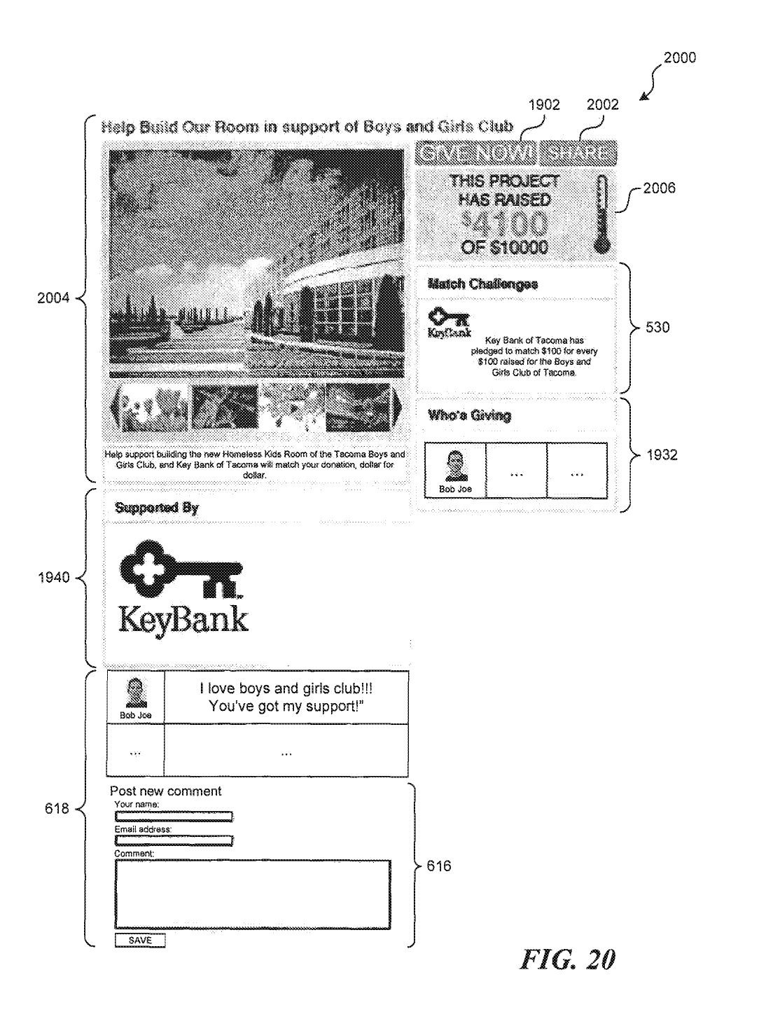

FIG. 20 is a schematic diagram of a “Giving” Web page. A Web page 2000 can be associated with a particular giving campaign, e.g., a donation opportunity. The Web page can provide a link 1902 that enables a user to donate immediately; a link 2002 to enable a user to share a link to the giving campaign, e.g., with other users, and an indication of a comparison between how much money has been raised thus far versus how much money the nonprofit entity desired for this particular giving campaign, e.g., in region 2006. The Web page 2000 can also include a region 530 that provides information about promotions that may be ongoing relating to entities that are willing to provide funds during sponsorship, e.g., by matching other people's sponsorship. The Web page 2000 can include a region 1932 to indicate who else is donating to this giving campaign. In various embodiments, selection of a region 1940 can cause a browser to navigate to a microsite or Web site associated with a sponsor of the giving campaign.

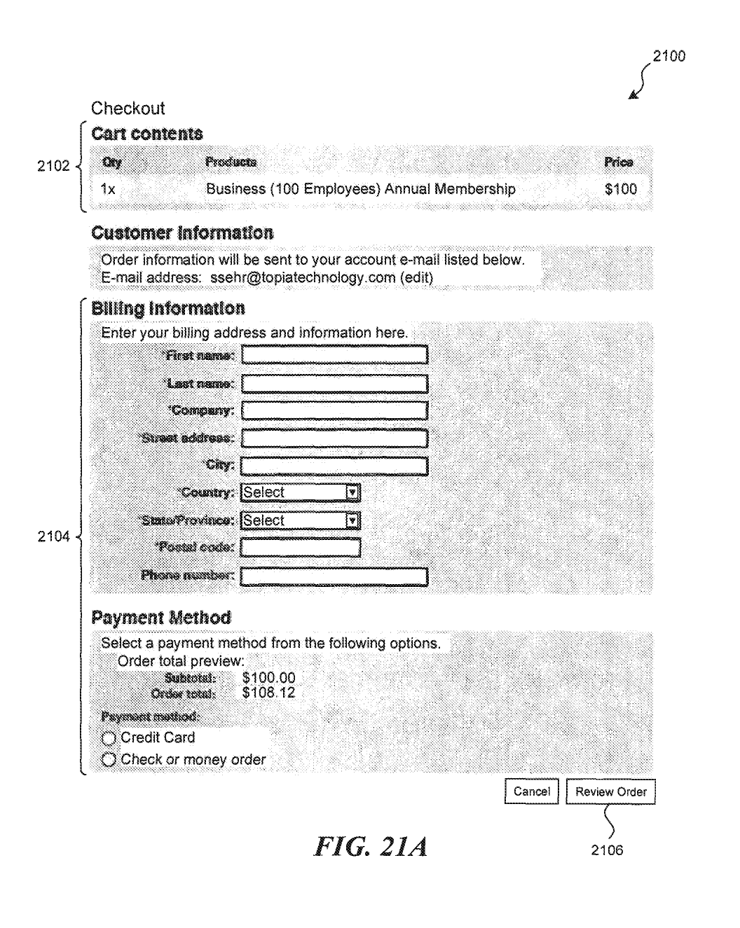

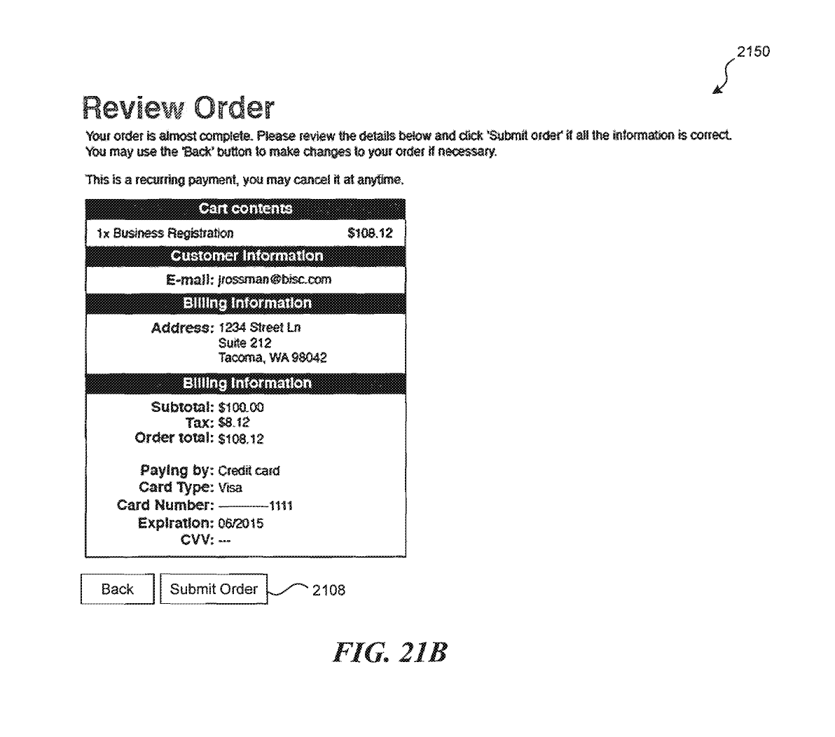

FIGS. 21A-21B are schematic diagrams of “Checkout” Web pages. In various embodiments, the Web site can enable nonprofit entities to collect donations during a checkout process at an electronic commerce Website, e.g., an electronic retailer, etc. As an example, during a checkout process, the electronic commerce Web site may enable users to add a donation amount as part of their payment. When the checkout process completes, the donation amount may be automatically credited to a particular nonprofit entity identified during the checkout process. Thus, the described technology enables “one-click giving.” In various embodiments, the checkout process can function separate from the electronic commerce or other external Web site, e.g., by enabling a user to make donations using credit cards, debit cards, or other forms of payment. FIG. 21B is a schematic diagram of an order review page 2150.

FIG. 22 is a schematic diagram of an “Affiliations” Web page. The affiliations Web page 2200 includes a region 2220 that a user can use to manage affiliations. In various embodiments, the user can specify whether or not to include an added affiliate in “roll-up giving.” When an affiliate is added to “roll-up giving,” that affiliate's giving information can be aggregated with other affiliates' giving information in various reports. When the affiliate is not added to “roll-up giving,” that affiliate's giving information will not be aggregated with other's giving information. Thus, a user can comply with privacy or other issues in relation to one or more affiliates. A user can add affiliations, e.g., by selecting a link 2232 and identifying affiliates. In various embodiments, the Web site 2200 can maintain various types of affiliations, e.g., employer/employee, entity relationships, customer/business, groups/friends, etc.

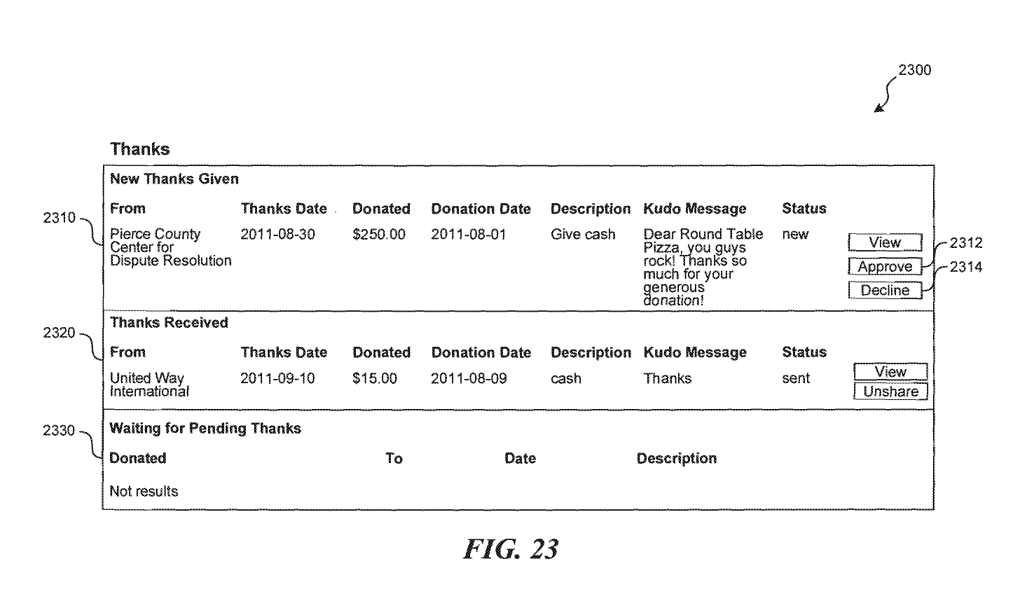

FIG. 23 is a schematic diagram of a “Thanks/Kudos approval” Web page. A Web page 2300 may be used by a user to manage “thanks” information. As an example, the user can employ the Web page 2300 to view, approve, decline, share, unshare thanks-related information posted by other users.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

I/we claim:

1. A method performed by a computing device having a processor and memory for matching funding needs of an entity in need of a donation, comprising:
receiving information about a potential donor's desired donating requirements;
storing the captured information in a database;
receiving information about a nonprofit entity;
receiving from the nonprofit entity a request for a donation;
automatically generating a list of matching potential donors, the list including the potential donor from which information was received, the list generated by matching the received information about the potential donor with the received information about the nonprofit entity; and
enabling a user of a Web site to accept or decline a donated item.

2. A computer-readable storage device storing instructions that, when executed, cause a computing device to enable matching of donors to nonprofit entities, the instructions comprising:
providing a list of potential donors in a Web page;
receiving a selection of one of the listed potential donors;
determining whether criteria specified by the selected potential donor matches information provided by an entity associated with a user viewing the Web page;
if the criteria specified by the selected potential donor matches the information provided by the entity, transmitting a donation request to the selected potential donor; and
if the criteria specified by the selected potential donor does not match the information provided by the entity, informing the user that a donation request cannot be transmitted to the selected potential donor.

3. A system, comprising:
a donation response tracking component configured to automatically send notification of a donation opportunity to a network of users, and track responses made by the users in the network; and
a component configured to cause an electronic commerce Web site to display a link that, when selected, accrues a donation in favor of an entity associated with the donation opportunity.
